(19) United States
(12) Patent Application Publication
(10) Pub. No.: US 2014/0350445 A1
(43) Pub. Date: Nov. 27, 2014

(54) MASSAGE ARCH

(71) Applicant: Yee-Lee Lok, Taipei City (TW)

(72) Inventors: Yee-Lee LOK, Taipei City (TW); Chen-Kuo LIN, New Taipei City (TW)

(73) Assignee: Yee-Lee Lok, Taipei City (TW)

(21) Appl. No.: 14/280,151

(22) Filed: May 16, 2014

(30) Foreign Application Priority Data
May 24, 2013 (TW) 102118325

(51) Int. Cl. A61H 1/00

(52) U.S. Cl. CPC A61H 1/008
USPC 601/137

(57) ABSTRACT

A massage arch including a central member; first and second grip members in a bending or an arc shape, where the first and second grip members respectively extend from two ends of the central member so that the grip members and the central member constitute an arcuate structure, and two hands grip the first and second grip members relative to a side or front of the body; and a massage head disposed on the central member, for massaging the body. The massage arch is a portable massage tool that enables users to self-massage various parts at the back of the body, which is used for daily health care; by operating the massage arch with a force applied by two hands on a side or in front of the body, it is easy to find the part to be massaged. The massage arch has a simple structure and a low cost.

### PRIORITY CLAIM

The present application claims priority to Taiwan Patent Application No. 102118325, filed on May 24, 2013, which said application is incorporated by reference in its entirety herein.

### FIELD OF THE INVENTION

The present invention relates to a massager, and particularly to a massage arch for massaging the body.

### BACKGROUND OF THE INVENTION

Due to the human body's reactions to tension and fatigue, it may easily lead to various problems such as insomnia or muscle aches, and according to the traditional Chinese medicine techniques, various points throughout the human body have been proved, which can take charge of reactions of various organs. By pressing or rubbing the points, effects of exercising the bones and muscles indeed can be achieved, massage for the points also can promote blood circulation, accelerate metabolism, discharge toxins from the body and thereby enhance immunity, so as to be able to eliminate fatigue and relieve stress, and even has lots of good effects such as body slimming and stimulation of growth hormone secretion.

To this end, the conventional design of various massager appliances provides assistance for pressing and rubbing different parts (points) of the human body, for example, generally granular attached rollers or massage bars, slap sticks and massage balls in various shapes, and even expensive electric massage chairs and other applications are all aimed at massage health care effects.

The electric massage chairs may achieve full-body massage effects, but they are bulky, are not easy to carry, moving them is inconvenient, and they cannot make immediate and appropriate adjustment for personal needs at a fixed point, in a fixed time, in a fixed direction, and with a fixed force. The massage bars, slap sticks or massage balls are small and are easy to carry, but it is not easy to massage various parts at the back of the body in self-operation, or when they are operated one-hand, the massage effects cannot be achieved due to insufficient massage force. There are also some massagers placed on the wall to press with a force when the body leans rearward, but it is necessary to swing the body, which is unnatural, and massaging needs to be relocated for each shift, which is very inconvenient, and thus the massage effects are not good.

FIG. 1 is a schematic view of a conventional massager massaging the body. In FIG. 1, an S-shaped massager 100 is formed with a plurality of massage points 104 on its body 102, for massaging different parts of the body, massage points in different positions on the body 102 are used for massage, and the body 102 is also formed with an auxiliary rod 106, so as to facilitate the user to grip the auxiliary rod 106 to operate the massager 100 to massage various parts of the body. However, compared with the portable massager, the S-shaped massager 100 has a complicated structure, operation thereof is inconvenient, and the cost thereof is more expensive.

### SUMMARY

In view of this, the present invention provides a massage arch, which is a portable massage tool that enables users to self-massage various parts at the back of the body, and is used for daily health care; by operating the massage arch with a force applied by two hands on a side or in the front of the body, there is enough force to effectively massage the back of the body, including parts to be massaged, such as shoulder blades, neck, back, waist, hip and thigh, it is easy to accurately find the parts to be massaged, and it is not the body but two hands that swing; thus, the operation thereof is very convenient, and the massage arch has a simple structure and a low cost. As the present invention relates to an arcuate massager and its handle is bent outwards, it may not touch the body in operation and may not produce stifling inconvenience. Meanwhile, the grip portion is parallel to the center of the arch body, it is easy to apply a force forward, and thus the force that presses the body is greater. The S-shaped massager only can make horizontal rubbing in one direction, and can press different parts of the body, and thus in use, it is usually necessary to move the S-shaped massager to the front of the body, so that massaging can be made only when a massage head is selected and moved to the back of the body, which is very inconvenient; however, the present invention fixedly uses one massage head, which does not need to constantly change sides or change the massage head in different positions like the S-shaped massager, one massage head is fixed to the center of the massage arch, two hands apply a force at two ends of the massage arch, and it is easy to make horizontal rubbing in any direction.

The present invention provides a massage arch, including:

a central member;

first and second grip members, in a bending shape or an arc shape, wherein the first and second grip members respectively extend from two ends of the central member, so that the first and second grip members and the central member constitute an arcuate structure, and two hands grip the first and second grip members relative to a side or the front of the body; and

a massage head disposed on the central member, for massaging the body.

### BRIEF DESCRIPTION OF THE DRAWINGS

FIG. 1 is a schematic view of a conventional massager massaging the body;

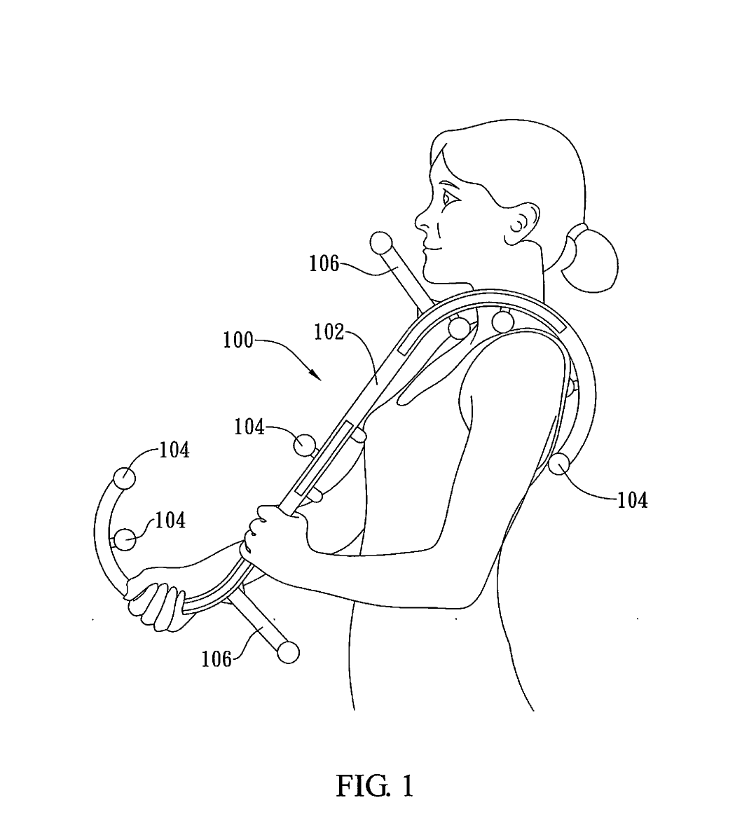

FIG. 2 is a schematic view of a massage arch according to a first embodiment of the present invention;

FIG. 3 is a sectional view along the II-II profile line in FIG. 2;

FIG. 4 is a partially enlarged view of the range of the circle A in FIG. 2;

FIG. 5 is a schematic view of a massage arch according to a second embodiment of the present invention;

FIG. 6 is a schematic view of a massage arch according to a third embodiment of the present invention;

FIG. 7 is a sectional view along the VI-VI profile line in FIG. 6; and

FIG. 8 is a schematic view of a massage arch according to a fourth embodiment of the present invention.

### DETAILED DESCRIPTION

Implementation aspects of the massage arch in the present invention are described with reference to the following embodiments.

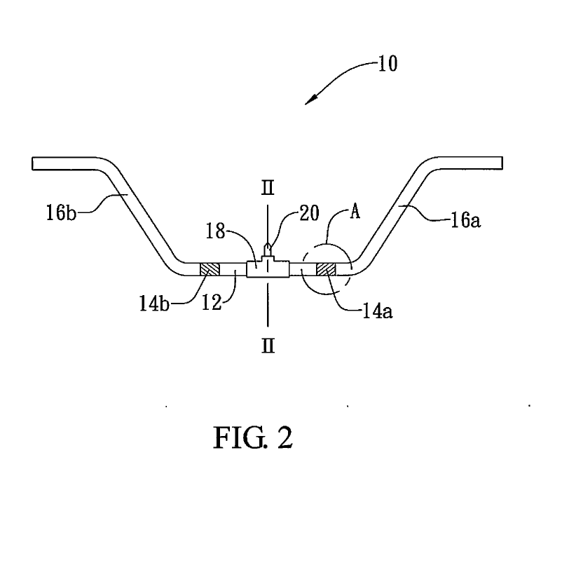

FIG. 2 is a schematic view of a massage arch according to a first embodiment of the present invention. In FIG. 2, a massage arch 10 includes a central member 12, a right grip member 16a, a left grip member 16b, a base 18 and a massage head 20.

The right grip member 16a in a bending shape is sleeved together with the central member 12 at a sleeve portion 14a on one end portion of the central member 12, and the left grip member 16b in a bending shape is sleeved together with the central member 12 at a sleeve portion 14b on the other end portion of the central member 12. The right grip member 16a and the left grip member 16b are sleeved to two ends of the central member 12 to become an arcuate massage arch 10, so that two hands can grip the right grip member 16a and the left grip member 16b relative to a side or the front of the body.

The central member 12, the right grip member 16a, the left grip member 16b and the base 18 are all made from a carbon fiber, plastic, light metal, wood or bamboo material, or are applied to materials known to the massager. The massage head 20 is made from a carbon fiber, plastic, light metal, wood, bamboo, stone, horn or ivory material, or is applied to materials known to the massage head of the massager.

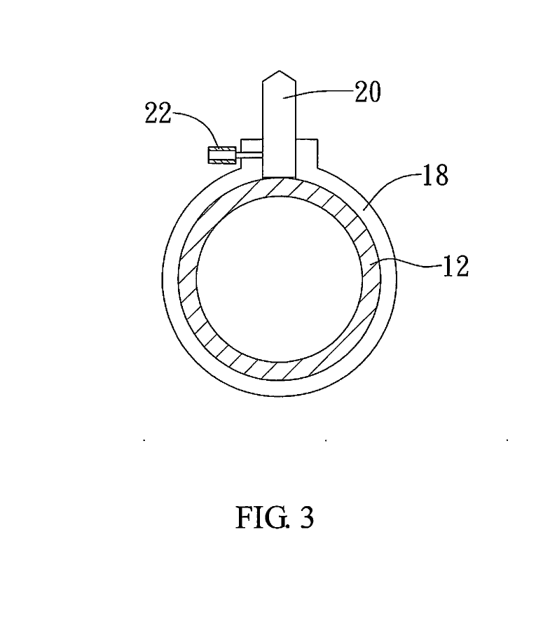

FIG. 3 is a sectional view along the II-II profile line in FIG. 2. In FIG. 3, the base 18 is sleeved to a middle position of the central member 12, which is not limited to the middle position, and the position where the base 18 is sleeved to the central member 12 may be adjusted right or left. The massage head 20 is disposed in the base 18, and the massage head 20 is used for massaging the body.

The base 18 is formed with an opening and a screw hole, the massage head 20 is disposed in the opening of the base 18, which is screwed into the screw hole of the base 18 through a screw 22, and the screwed screw 22 presses against the massage head 20 to fixedly connect the base 18 with the massage head 20.

In another embodiment, the massage head 20 may use the conventional electric massage head and is disposed on the base 18, and when the electric massage head is pressed on the body, the electric massage head may automatically massage the body, which makes operation of the massage arch more convenient and labor-saving.

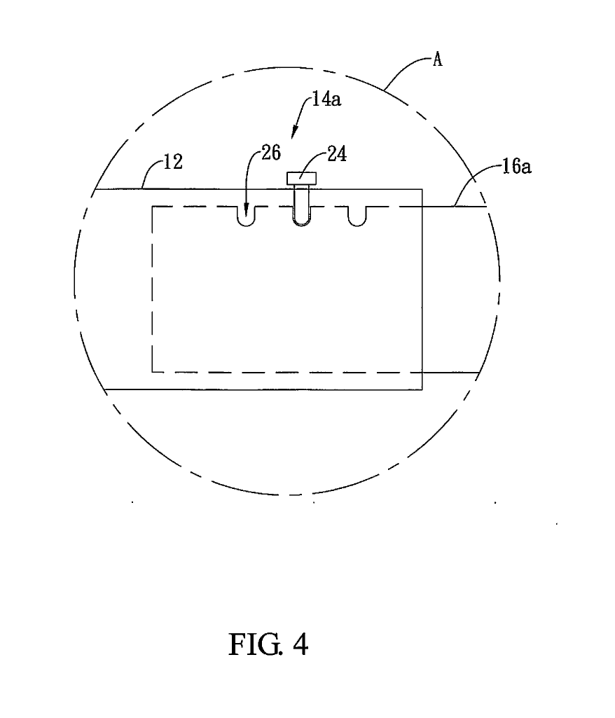

FIG. 4 is a partially enlarged view of the range of the circle A in FIG. 2. In FIG. 4, the right grip member 16a is sleeved to the sleeve portion 14a of the central member 12, that is, the sleeve portion 14a of the central member 12 is formed with a screw hole, one end portion of the right grip member 16a is formed with at least one recessed portion 26, the end portion of the right grip member 16a is sleeved into the sleeve portion 14a of the central member 12, which is screwed into the screw hole of the sleeve portion 14a of the central member 12 through a screw 24, and the screwed screw 24 presses against the recessed portion 26 of the right grip member 16a to fixedly connect the central member 12 with the right grip member 16a. The manner in which the left grip member 16b is sleeved with the central member 12 is identical with the manner in which the right grip member 16a is sleeved with the central member 12, and thus the description thereof is omitted herein.

Massage, as the name suggests, includes movement in two directions, that is, press (force perpendicular to the surface of the body) and rub (force horizontal to the surface of the body), and fixed points at the back can be pressed and rubbed at the same time only with two hands. The right grip member 16a and the left grip member 16b of the massage arch 10 in the present invention are in a bending shape, and positions where the two hands grip the right grip member 16a and the left grip member 16b are relative to a side or the front of the body, so that the two hands can conveniently apply a force to the massage arch 10, without turning the hands to the back of the body to apply a force.

According to the structure of the arcuate massage arch 10 stated above, two hands grip the right grip member 16a and the left grip member 16b, the two hands adjust positions and angles of the massage arch 10 relative to the body with the parts of the body to be massaged, so that the two hands can conveniently operate the massage arch 10, and the force applied by the two hands are concentrated at the massage head 20, to make the massage head 20 effectively achieve the massage effects. Moreover, the arcuate massage arch 10 has a simple structure, and the operation thereof is quite convenient.

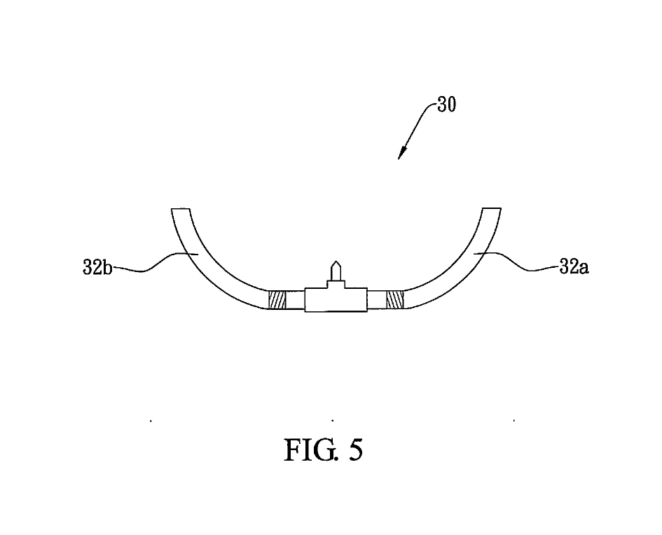

FIG. 5 is a schematic view of a massage arch according to a second embodiment of the present invention. In FIG. 5, the difference between the structure of the massage arch 30 in the second embodiment and the structure of the massage arch 10 in the first embodiment lies in that the right grip member 32a and the left grip member 32b of the arcuate massage arch 30 have an arc-shaped structure, while other structures of the massage arch 30 and the effects achieved are identical with those of the massage arch 10 in the first embodiment, and thus the description thereof is omitted herein.

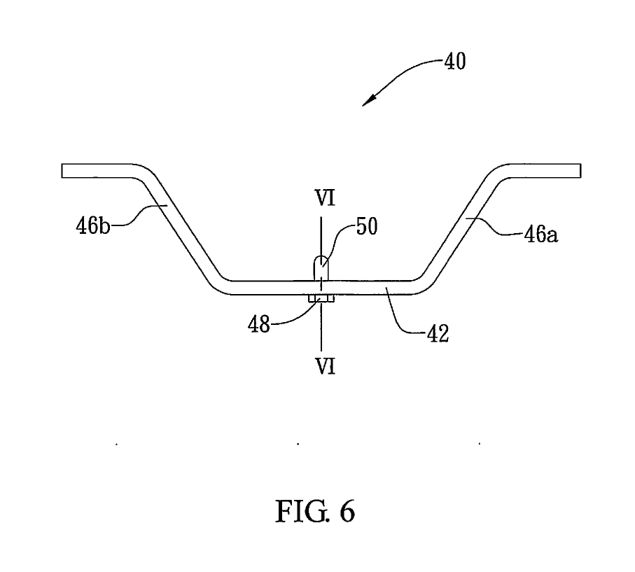

FIG. 6 is a schematic view of a massage arch according to a third embodiment of the present invention. In FIG. 6, a massage arch 40 includes a central member 42, a right grip member 46a, a left grip member 46b and a massage head 50.

The right grip member 46a and the left grip member 46b in a bending shape respectively extend from two ends of the central member 42, so that the right grip member 46a and the left grip member 46b and the central member 42 integrally constitute the arcuate massage arch 40, so that two hands can grip the right grip member 46a and the left grip member 46b relative to a side or the front of the body.

The materials that the central member 42, the right grip member 46a, the left grip member 46b and the massage head 50 in the third embodiment use are identical with the materials that the central member 12, the right grip member 16a, the left grip member 16b and the massage head 20 in the first embodiment use, and thus the description thereof is omitted herein.

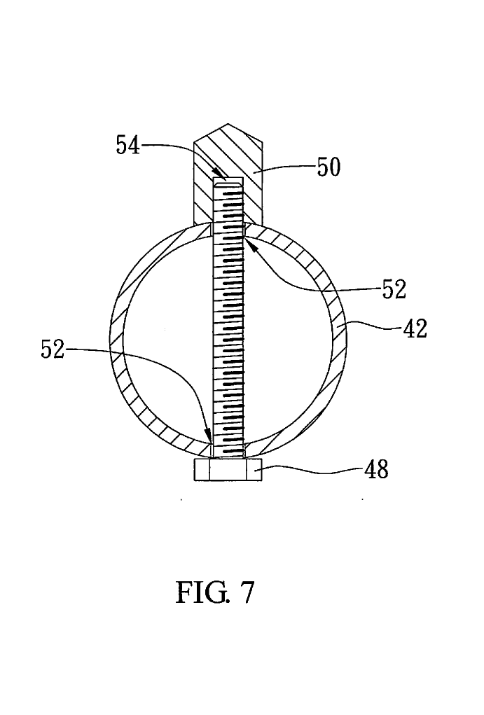

FIG. 7 is a sectional view along the VI-VI profile line in FIG. 6. In FIG. 7, the central member 42 is formed with a through hole 52, the bottom of the massage head 50 is formed with an orifice 54 having an inner thread, which passes through the through hole 52 of the central member 42 through a screw 48 to be screwed with the orifice 54 of the massage head 50 having an inner thread, so that the massage head 50 is fixed onto the central member 42. The massage head 50 is used for massaging the body.

In another embodiment, the central member is formed with a through hole, the bottom of the massage head is provided with a screw, and the screw of the massage arch passes through the through hole of the central member to be screwed with a nut, so that the massage head is fixed onto the central member.

In a further embodiment, the massage head and the central member are integrally formed. The operating manner of the massage arch 40 in the third embodiment and the effects achieved are identical with those of the massage arch 10 in the first embodiment, and thus the description thereof is omitted herein.

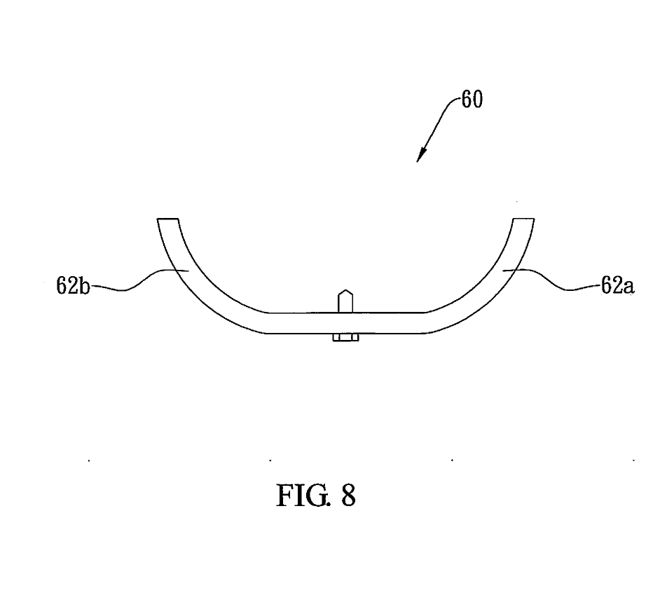

FIG. 8 is a schematic view of a massage arch according to a fourth embodiment of the present invention. In FIG. 8, the difference between the structure of the massage arch 60 in the fourth embodiment and the structure of the massage arch 40 in the third embodiment lies in that the right grip member 62a and the left grip member 62b of the arcuate massage arch 60 have an arc-shaped structure, while other structures of the massage arch 60 and the effects achieved are identical with those of the massage arch 40 in the third embodiment, and thus the description thereof is omitted herein.

The present invention provides a massage arch, and its advantages lie in that the massage arch is a portable massage tool that enables users to self-massage various parts at the back of the body, which is used for daily health care; by operating the massage arch with a force applied by two hands on a side or in the front of the body, there is enough force to effectively massage the back of the body, including parts to be massaged, such as shoulder blades, neck, back, waist, hip and thigh, it is easy to accurately find the parts to be massaged, and it is not the body but two hands that swing; thus, the operation thereof is very convenient, and the massage arch has a simple structure and a low cost.

Although the present invention has been described above with reference to preferred embodiments and exemplary drawings, they cannot be regarded as limitations to the present invention. Various modifications, omissions and variations made by persons skilled in the art to the forms thereof and content of the embodiments should not depart from the scope as defined by the claims of the present invention.

### DESCRIPTION ABOUT REFERENCE SIGNS

10 Massage arch

12 Central member

14a Sleeve portion

14b Sleeve portion

16a Right grip member

16b Left grip member

18 Base

20 Massage head

22 Screw

24 Screw

26 Recessed portion

30 Massage arch

32a Right grip member

32b Left grip member

40 Massage arch

42 Central member

46a Right grip member

46b Left grip member

48 Screw

50 Massage head

52 Through hole

54 Orifice

100 Massager

102 Body

104 Massage point

106 Auxiliary rod

What is claimed is:

1. A massage arch, comprising:
a central member;
first and second grip members, in a bending shape or an arc shape, wherein the first and second grip members respectively extend from two ends of the central member, so that the first and second grip members and the central member constitute an arcuate structure, and two hands grip the first and second grip members relative to a side or the front of the body; and
a massage head disposed on the central member, for massaging the body.

2. The massage arch according to claim 1, wherein the central member is formed with a through hole, the bottom of the massage head is formed with an orifice having an inner thread, which passes through the through hole of the central member through a screw to be screwed with the orifice having an inner thread of the massage head, so that the massage head is fixed onto the central member.

3. The massage arch according to claim 1, wherein the central member is formed with a through hole, the bottom of the massage head is provided with a screw, and the screw of the massage arch passes through the through hole of the central member to be screwed with a nut, so that the massage head is fixed onto the central member.

4. The massage arch according to claim 1, wherein the central member is made from one of the following materials: carbon fiber, plastic, light metal, wood and bamboo.

5. The massage arch according to claim 1, wherein the first and second grip members are made from one of the following materials: carbon fiber, plastic, light metal, wood and bamboo.

6. The massage arch according to claim 1, wherein the massage head is made from one of the following materials: carbon fiber, plastic, light metal, wood, bamboo, stone, horn and ivory.

7. A massage arch, comprising:
a central member;
first and second grip members, in a bending shape or an arc shape, respectively sleeved to two ends of the central member, making the first and second grip members and the central member constitute an arcuate structure, and two hands grip the first and second grip members relative to a side or the front of the body;
a base, sleeved to a middle position of the central member; and
a massage head disposed on the base, wherein the massage head is used for massaging the body.

8. The massage arch according to claim 7, wherein two end portions of the central member are formed with a screw hole, one end portion of the first and second grip members is formed with at least one recessed portion, the one end portion of the first and second grip members is sleeved in the two end portions of the central member respectively, which is screwed into the screw hole of the two end portions of the central member through a screw, and the screwed screw presses against the recessed portion of the first and second grip members to fixedly connect the central member with the first and second grip members.

9. The massage arch according to claim 7, wherein the base is formed with an opening and a screw hole, the massage head is disposed in the opening of the base, which is screwed into the screw hole of the base through a screw, and the screwed screw presses against the massage head to fixedly connect the base with the massage head.

10. The massage arch according to claim 7, wherein the central member is made from one of the following materials: carbon fiber, plastic, light metal, wood and bamboo.

11. The massage arch according to claim 7, wherein the first and second grip members are made from one of the following materials: carbon fiber, plastic, light metal, wood and bamboo.

12. The massage arch according to claim 7, wherein the base is made from one of the following materials: carbon fiber, plastic, light metal, wood and bamboo.

13. The massage arch according to claim 7, wherein the massage head is made from one of the following materials: carbon fiber, plastic, light metal, wood, bamboo, stone, horn and ivory.

14. The massage arch according to claim 7, wherein the massage head is an electric massage head.
